(19) United States
(12) Patent Application Publication
(10) Pub. No.: US 2022/0121134 A1
(43) Pub. Date: Apr. 21, 2022

(54) Liquid Developer, Image Forming Method, Liquid Developer Cartridge, and Image Forming Apparatus

(71) Applicant: Mitsubishi Chemical Corporation, Tokyo (JP)

(72) Inventors: Akiteru Fujii, Tokyo (JP); Yuqing Xu, Tokyo (JP); Yuuta Kumano, Tokyo (JP); Toshihisa Ishihara, Tokyo (JP)

(73) Assignee: Mitsubishi Chemical Corporation, Tokyo (JP)

(21) Appl. No.: 17/567,247

(22) Filed: Jan. 3, 2022

Related U.S. Application Data
(63) Continuation of application No. PCT/JP2020/025906, filed on Jul. 1, 2020.

(30) Foreign Application Priority Data
Jul. 2, 2019 (JP) 2019-123721

(51) Int. Cl. G03G 9/13; G03G 9/125

(52) U.S. Cl. CPC G03G 9/133; G03G 9/125

(57) ABSTRACT

The present invention relates to a liquid developer containing a carrier liquid and a developer component, in which the developer component contains an ethylene-(meth)acrylic acid copolymer A and a block copolymer B′ containing a hard segment and a soft segment, and the hard segment is a vinyl alicyclic hydrocarbon polymer, an image forming method using the liquid developer, a liquid developer cartridge having the liquid developer and an image forming apparatus having the liquid developer.

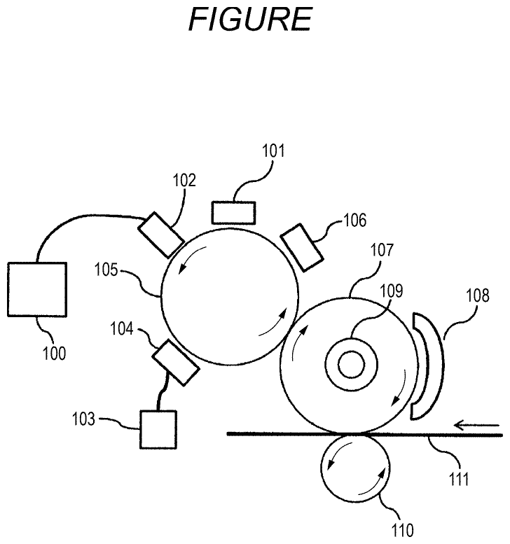

### TECHNICAL FIELD

The present invention relates to a liquid developer to be used in an electrophotographic printer and a printing machine of a liquid developing method. In addition, the present invention relates to an image forming method, a liquid developer cartridge, and an image forming apparatus using the liquid developer.

### BACKGROUND ART

In a printing method using an electrophotographic process, the thickness of a developing layer and the particle diameter of a developer in printing of a liquid developing method are closer to those in an offset printing method and a gravure printing method than those in printing of a dry developing method, and high quality and high definition image quality can be obtained. Therefore, the use of the printing of a liquid developing method is expanding in commercial digital printing applications where variable data printing is possible.

Examples of the liquid developing method include a method using a high boiling point hydrocarbon solvent as a carrier liquid, using a polyolefin-based resin having a glass transition point of 100° C. or lower as a base resin of a developer, and using an intermediate transfer body. In this method, an attempt has been made to apply a developing layer containing a solvent to various printing media by bringing the developing layer containing a solvent into a semi-dry state on the intermediate transfer body and then performing pressure transfer and fixation on a printing medium at a relatively low temperature (100° C. or lower).

As means of improving fixability of a liquid developer, a method using ultraviolet curing (Patent Literature 1) etc. is known. However, the use of a UV curable material is not preferred from the viewpoints of pot life of the developer and compound safety.

### CITATION LIST

### Patent Literature

Patent Literature 1: JP-A-2015-127812

### SUMMARY OF INVENTION

### Technical Problem

In order to be printed on various non-penetrating printing media, the liquid developer is required to have good transferability from the intermediate transfer body at a relatively low temperature and good fixability to the printing media. On the other hand, when one printed with the liquid developer is used for packaging, the developing layer after printing may not withstand a high temperature (for example, 100° C. to 120° C.) treatment such as a sterilization treatment and a retort treatment and may melt. Therefore, the liquid developer has a problem in terms of heat resistance.

The present invention has been made in view of the above circumstances, and an object thereof is to provide a liquid developer having good transferability from an intermediate transfer body, good fixability to a printing medium, and heat resistance at a high temperature.

### Solution to Problem

As a result of diligent investigation, the inventors of the present invention have found that when a liquid developer containing an ethylene-(meth)acrylic acid polymer and a polymer having a specific structure is used, it is possible to achieve good transferability from an intermediate transfer body, and also good fixability and heat resistance at a high temperature after printing. Thus, the present invention has been accomplished as follows.

Namely, the gist of the present invention is in the following <1> to <14>.

<1> A liquid developer containing a carrier liquid and a developer component,

wherein the developer component contains an ethylene-(meth)acrylic acid copolymer A and a block copolymer B′ containing a hard segment and a soft segment, and

the hard segment is a vinyl alicyclic hydrocarbon polymer.

<2> The liquid developer according to <1>, wherein the block copolymer B′ has a repeating unit of the following Formula (1).

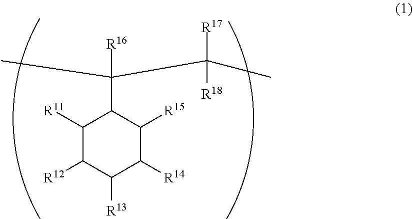

(In Formula (1), R¹¹ to R¹⁸ each independently represent a hydrogen atom, a halogen atom, a hydrocarbon group, or an alkoxy group.)

<3> The liquid developer according to <1> or <2>, wherein a content of the block copolymer B′ is 5 mass % or more and 50 mass % or less with respect to a total amount of the ethylene-(meth)acrylic acid copolymer A and the block copolymer B′.
<4> The liquid developer according to any one of <1> to <3>, wherein the block copolymer B′ further contains a repeating unit of the following Formula (2).

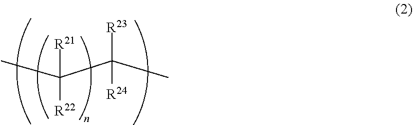

(In Formula (2), R²¹ to R²⁴ each independently represent a hydrogen atom, a halogen atom, a hydrocarbon group or an alkoxy group, and n represents an integer of 1 or more, with the proviso that when n is 2 or more, a plurality of R²¹ and R²² may be the same or different.)

<5> The liquid developer according to <4>, wherein the block copolymer B′ contains at least two polymer blocks P having Formula (1) as a repeating unit and at least one polymer block Q having Formula (2) as a repeating unit.
<6> The liquid developer according to <4> or <5>, wherein when a content of the repeating unit of Formula (1) in the block copolymer B′ is b1% by mass, and a content of the repeating unit of Formula (2) in the block copolymer B′ is b2% by mass, b1/b2 is 0.050 or more and 19 or less.
<7> The liquid developer according to <6>, wherein the b1/b2 is 0.67 or more and 9.0 or less.
<8> The liquid developer according to any one of <1> to <7>, wherein a content of a moiety derived from (meth)acrylic acid in the ethylene-(meth)acrylic acid copolymer A is 1 mass % or more and 30 mass % or less.
<9> The liquid developer according to any one of <1> to <8>, wherein the carrier liquid contains at least one selected from the group consisting of a paraffin, a naphthene and an olefin.
<10> The liquid developer according to any one of <1> to <8>, wherein the carrier liquid contains isoparaffin.
<11> An image forming method using the liquid developer according to any one of <1> to <10>.
<12> A liquid developer cartridge having the liquid developer according to any one of <1> to <10>.
<13> An image forming apparatus having the liquid developer according to any one of <1> to <10>.
<14> A liquid developer containing a carrier liquid and a developer component,

wherein the developer component contains an ethylene-(meth)acrylic acid copolymer A and a polymer B containing a repeating unit of the following Formula (1).

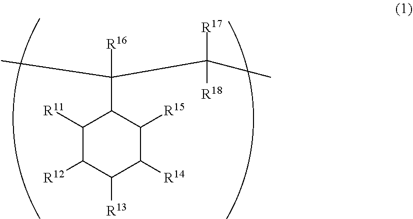

(In Formula (1), R¹¹ to R¹⁸ each independently represent a hydrogen atom, a halogen atom, a hydrocarbon group, or an alkoxy group.)

### Effects of Invention

By using the liquid developer of the present invention, printing on various film printing media without an undercoat layer (primer layer) can be achieved. In addition, since the liquid developer of the present invention has good transferability from an intermediate transfer body, good fixability at a low temperature, and heat resistance at a high temperature, printing for a wide range of applications using the liquid development method can be achieved.

### BRIEF DESCRIPTION OF DRAWING

The FIGURE is a schematic diagram illustrating an image forming method according to the present invention.

### DESCRIPTION OF EMBODIMENTS

Hereinafter, although embodiments of the present invention will be described in detail, the following description is a representative example of the embodiments of the present invention, and can be appropriately modified and implemented without departing from the spirit of the present invention.

In the present invention, “(meth)acrylic” means either “acrylic” or “methacrylic”.

### [1] Liquid Developer

The liquid developer of the present invention contains a carrier liquid and a developer component.

The developer component is a component other than the carrier liquid in the liquid developer. The developer component in the liquid developer of the present invention contains a copolymer A to be described later and a block copolymer B′ to be described later. In addition, a developer component in a liquid developer according another embodiment of the present invention contains a copolymer A to be described later and a polymer B to be described later.

The liquid developer of the present invention can further contain a colorant or an additive, if necessary.

### <Carrier Liquid>

The carrier liquid is a medium for dissolving or dispersing the developer component, and can impart fluidity to the liquid developer. The carrier liquid is not particularly limited, and is preferably a liquid at normal temperature and pressure, and preferably has insulation properties. The expression “insulation properties” means that the electrical conductivity is 1×10⁻¹⁰ S/m or less. The carrier liquid may be either non-volatile or volatile, and a volatile carrier liquid is preferred. The expression “volatile” means that the flash point is 130° C. or lower, or the volatilization amount when being left at 150° C. for 24 hours is 8 mass % or more. The flash point is the temperature measured according to JIS K2265-4:2007.

The components of the carrier liquid are not particularly limited, and it is preferable that the carrier liquid contains a hydrocarbon which is liquid at normal temperature and pressure. The ratio of the hydrocarbon which is liquid at normal temperature and pressure to the entire carrier liquid is preferably 50 mass % or more, more preferably 80 mass % or more, still more preferably 90 mass % or more, and particularly preferably 95 mass % or more.

Examples of the hydrocarbons which are liquid at normal temperature and pressure include an aliphatic hydrocarbon and an aromatic hydrocarbon, and an aliphatic hydrocarbon is preferred. Specific examples thereof include a paraffin, a naphthene, and an olefin, and a paraffin is preferred. Specific examples of the paraffin include isoparaffin and normal paraffin, and among these, isoparaffin is more preferred. These may be used alone or in combination of two or more thereof.

Examples of a commercially available product of the liquid hydrocarbons at normal temperature and pressure include: “ISOPAR L” (isoparaffin), “ISOPAR M” (isoparaffin), “EXXSOL D80” (naphthene), “EXXSOL D110” (naphthene), “SOLVESSO 100” (aromatic hydrocarbon), and “SOLVESSO 150” (aromatic hydrocarbon), manufactured by Exxon Mobil Corporation; “MORESCO White P-40” (paraffin), “MORESCO White P-70” (paraffin), “MORESCO White P-80” (paraffin), and “MORESCO White P-100” (paraffin), “Moresco White P-200” (paraffin), manufactured by MORESCO Corporation; and “Naphthesol 200” (naphthene) and “naphthesol 220” (naphthene) manufactured by JXTG Nippon Oil & Energy Corporation.

The carrier liquid may contain components other than the hydrocarbon which is liquid at normal temperature and pressure. Examples of the components other than the hydrocarbon which is liquid at normal temperature and pressure include: silicone oils such as dimethyl silicone oil, methylhydrogen silicone oil, and methylphenyl silicone oil; and polyol compounds such as ethylene glycol, diethylene glycol and propylene glycol. These may be used alone or in combination of two or more thereof

### <Developer Component>

The developer component contains an ethylene-(meth)acrylic acid copolymer A and a block copolymer B′. In addition, the developer component according to another embodiment of the present invention contains the ethylene-(meth)acrylic acid copolymer A and a polymer B.

(1) Ethylene-(Meth)Acrylic Acid Copolymer A

The developer component contains an ethylene-(meth)acrylic acid copolymer A. In the ethylene-(meth)acrylic acid copolymer A, a component other than ethylene and (meth)acrylic acid may be further copolymerized.

The content of a (meth)acrylic acid-derived moiety in the ethylene-(meth)acrylic acid copolymer A is not particularly limited. From the viewpoint of balance between fixability and crystallinity, the content of the (meth)acrylic acid-derived moiety is generally 1 mass % or more, preferably 3 mass % or more, and more preferably 5 mass % or more, and is generally 30 mass % or less, preferably 25 mass % or less, and more preferably 20 mass % or less, in terms of mass percentage.

The melt mass flow rate (JIS K7210: 1999, 190° C./2.16 kg load) of the ethylene-(meth)acrylic acid copolymer A is preferably 10 g/10 min to 800 g/10 min. When the melt mass flow rate is within the above range, an ethylene-methacrylic acid copolymer and an ethylene-acrylic acid copolymer may be mixed and used in an optional ratio.

The melting point of the ethylene-(meth)acrylic acid copolymer A is not particularly limited, and from the viewpoint of fixing strength, is generally 80° C. or higher, preferably 90° C. or higher, and more preferably 92° C. or higher, and from the viewpoint of applicability to various printing media, is generally 120° C. or lower, preferably 110° C. or lower, and more preferably 100° C. or lower.

The ethylene-(meth)acrylic acid copolymer A may be used alone, or may be used as a mixture of two or more having different copolymerization ratios, melting points, melt mass flow rates, and the like.

Examples of the ethylene-(meth)acrylic acid copolymer A include NUCREL (registered trademark) N1035, N1050H, N1110H, N1525, and N1560, manufactured by DOW-MITSUI POLYCHEMICALS CO., LTD., A-05120, A-05180, and A-0540 manufactured by Honeywell Japan Ltd., and REXPEARL (registered trademark) A201M, A221M, and A211S manufactured by Japan Polyethylene Corporation.

(2) Block Copolymer B′

The developer component contains a block copolymer B′ having a hard segment and a soft segment. Here, the hard segment and the soft segment mean different block units constituting the block copolymer. Therefore, there is no need to clearly identify whether the segment is “hard” or “soft”. Specific examples of the hard segment and the soft segment include combinations of a crystalline segment and an amorphous segment, a high melting point segment and a low melting point segment, a segment having a high glass transition temperature and a segment having a low glass transition temperature, and a segment having a high storage elastic modulus and a segment having a low storage elastic modulus. Alternatively, the hard segment and the soft segment may each reverse to the above combinations.

### (2-1) Hard Segment and Soft Segment

In the present invention, the hard segment is a vinyl alicyclic hydrocarbon polymer. Examples of the vinyl alicyclic hydrocarbon include monocyclic vinylcycloalkanes such as vinylcyclopropane, vinylcyclobutane, vinylcyclopentane, vinylcyclohexane, vinylcycloheptane, vinylcyclooctane, vinylcyclononane, and vinylcyclodecane; and polycyclic vinylcycloalkanes such as 1-vinyldecahydronaphthalene, 1-vinyladamantane, 2-vinylbicyclo[2.2.1]heptane, 7-vinylbicyclo[4.1.0]heptane, and 1-vinylspiro[2.2]pentane. Among these, monocyclic vinylcycloalkanes are preferred, and vinylcyclopentane, vinylcyclohexane, vinylcycloheptane and vinylcyclooctane are more preferred.

The hydrogen atom constituting the alicyclic hydrocarbon may be substituted with a halogen atom, a hydrocarbon group, or an alkoxy group. Further, the hydrogen atom constituting the vinyl group may also be substituted with a halogen atom, a hydrocarbon group, or an alkoxy group.

Examples of the halogen atom include a fluorine atom, a chlorine atom, a bromine atom and an iodine atom, and a fluorine atom and a chlorine atom are preferred. Examples of the hydrocarbon group include an alkyl group, an alkenyl group, and an alkynyl group, and an alkyl group and an alkenyl group are preferred, and an alkyl group is more preferred. The number of carbon atoms in the hydrocarbon group and the alkoxy group is not particularly limited, and is generally 10 or less, preferably 8 or less, more preferably 6 or less, even more preferably 4 or less, still more preferably 3 or less, particularly preferably 2 or less, and most preferably 1.

A repeating unit constituting the vinyl alicyclic hydrocarbon polymer is more preferably a repeating unit represented by Formula (1) described later.

Examples of a raw material monomer of the soft segment include a linear hydrocarbon with one or two terminal double bonds, a branched hydrocarbon having a side chain structure with one or two terminal double bonds, and a hydrocarbon ether with one or two terminal double bonds. Among these, the linear hydrocarbon with one or two terminal double bonds and the branched hydrocarbon having a side chain structure with one or two terminal double bonds are preferred, and the linear hydrocarbon with one or two terminal double bonds is more preferred.

A repeating unit constituting the soft segment is more preferably a repeating unit of Formula (2) described later.

As the content ratio of the hard segment and the soft segment in the block copolymer B′, the content of the soft segment is generally 5 parts by mass or more, preferably 10 parts by mass or more, and more preferably 15 parts by mass or more, and is 2000 parts by mass or less, preferably 150 parts by mass or less, and more preferably 100 parts by mass or less, with respect to 100 parts by mass of the hard segment.

When the content ratio is equal to or larger than the lower limit value, the block copolymer B′ has appropriate crystallinity, which is thus preferred from the viewpoints of heat resistance and transferability. On the other hand, when the content ratio is equal to or less than the upper limit value, the affinity for a substrate is increased, which is thus preferred from the viewpoint of adhesiveness.

### (3) Polymer B

The developer component according to another embodiment of the present invention contains a polymer B having a repeating unit of Formula (1) described later. In the present description, the “repeating unit” does not necessarily mean only that the same structure is continuous, and as long as it is a structural unit derived from a raw material monomer, it is referred to as a “repeating unit”.

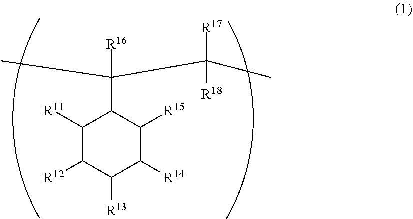

(In Formula (1), R¹¹ to R¹⁸ each independently represent a hydrogen atom, a halogen atom, a hydrocarbon group, or an alkoxy group.)

Among the hydrogen atom, the halogen atom, the hydrocarbon group, or the alkoxy group, the hydrogen atom, the hydrocarbon group and the alkoxy group are preferred, the hydrogen atom and the hydrocarbon group are more preferred, and the hydrogen atom is still more preferred.

Examples of the halogen atom include a fluorine atom, a chlorine atom, a bromine atom, an iodine atom and an astatine atom. The fluorine atom, the chlorine atom, the bromine atom and the iodine atom are preferred, the fluorine atom, the chlorine atom and the bromine atom are more preferred, and the fluorine atom and the chlorine atom are still more preferred.

Examples of the hydrocarbon group include an alkyl group, an alkenyl group, and an alkynyl group, and the alkyl group and the alkenyl group are preferred, and the alkyl group is more preferred.

The number of carbon atoms in the hydrocarbon group and the alkoxy group is not particularly limited, and is generally 10 or less, preferably 8 or less, more preferably 6 or less, even more preferably 4 or less, still more preferably 3 or less, particularly preferably 2 or less, and most preferably 1.

Preferred structures of Formula (1) are as follows.

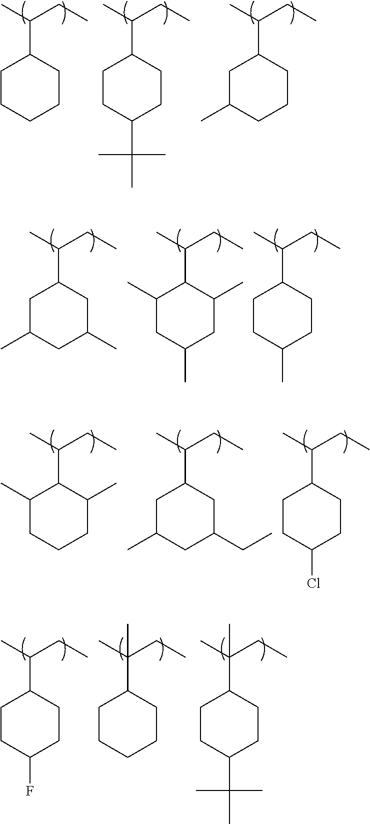

Among the above structure, more preferred structures are as follows.

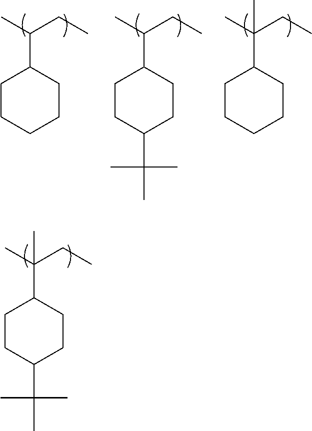

Among the above structure, even more preferred structures are as follows.

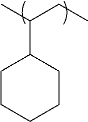

The content of the repeating unit of the above Formula (1) contained in the block copolymer B′ or the polymer B is not particularly limited, and is generally 30 mass % or more, preferably 40 mass % or more, and more preferably 50 mass % or more, and is generally 95 mass % or less, preferably 90 mass % or less, and more preferably 85 mass % or less.

The number average molecular weight (Mn) of block copolymer B′ or the polymer B is generally 30,000 or more, preferably 40,000 or more, more preferably 45,000 or more, and most preferably 50,000 or more, and is generally 120,000 or less, preferably 100,000 or less, more preferably 95,000 or less, even more preferably 90,000 or less, particularly preferably 85,000 or less, and especially preferably 80,000 or less. Here, the number average molecular weight (Mn) of the block copolymer B′ or the polymer B is a value in terms of polystyrene determined by gel permeation chromatography (GPC).

Further, each of the block copolymer B′ and the polymer B preferably has the following physical properties.

Density (ASTM D792): 0.92 g/cm³ to 0.96 g/cm³

MFR (melt flow rate) [ISO R1133 (measurement temperature: 230° C., load: 2.16 kg)]: 1 g/10 min to 300 g/10 min

Glass transition temperature (Tg): 110° C. to 150° C.

When the density of block copolymer B′ and the polymer B is equal to or larger than the above lower limit value, the heat resistance tends to be good, and when the density is equal to or less than the above upper limit value, the impact resistance and flexibility tend to be good. Further, it is preferable that the MFR of the block copolymer B′ and the polymer B is within the above range from the viewpoint of fluidity during fixing. The glass transition temperature of the block copolymer B′ and the polymer B is more preferably 115° C. or higher from the viewpoint of heat resistance, while the glass transition temperature is more preferably 135° C. or lower from the viewpoint of production of the developer.

As the block copolymer B′ and the polymer B, commercially available ones can be used, and specific examples thereof include Zelas (registered trademark) manufactured by Mitsubishi Chemical Corporation.

(Case where Polymer B is a Copolymer)

The polymer B may be a homopolymer composed of the repeating unit of the above Formula (1), and may be a copolymer containing another structure (hereinafter, may be referred to as a second structure) in addition to the repeating unit of the above Formula (1). The polymer B is preferably a copolymer.

When the polymer B is a copolymer, the second structure is not particularly limited.

### (Repeating Unit Represented by Formula (2))

Each of the block copolymer B′ and the polymer B is preferably a copolymer further having the repeating unit of the following Formula (2).

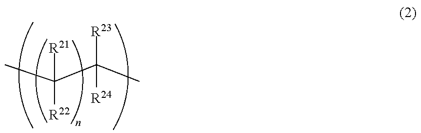

(In Formula (2), R²¹ to R²⁴ each independently represent a hydrogen atom, a halogen atom, a hydrocarbon group or an alkoxy group, and n represents an integer of 1 or more. When n is 2 or more, a plurality of R²¹ and R²² may be the same or different.)

R²¹ to R²⁴ is preferably a hydrogen atom, a hydrocarbon group or an alkoxy group, and more preferably a hydrogen atom and a hydrocarbon group.

Examples of the halogen atom include a fluorine atom, a chlorine atom, a bromine atom, an iodine atom and an astatine atom. A fluorine atom, a chlorine atom, a bromine atom and an iodine atom are preferred, a fluorine atom, a chlorine atom and a bromine atom are more preferred, and a fluorine atom and a chlorine atom are even more preferred.

Examples of the hydrocarbon group include an alkyl group, an alkenyl group, and an alkynyl group, and an alkyl group and an alkenyl group are preferred, and an alkyl group is more preferred.

The number of carbon atoms in the hydrocarbon group and the alkoxy group is not particularly limited, and is generally 10 or less, preferably 8 or less, more preferably 6 or less, even more preferably 4 or less, still more preferably 3 or less, particularly preferably 2 or less, and most preferably 1.

n represents an integer of 1 or more, and preferably 2 or more, and is generally 10 or less, preferably 9 or less, more preferably 8 or less, even more preferably 7 or less, still more preferably 6 or less, and particularly preferably 5 or less.

Preferred examples of Formula (2) are as follows.

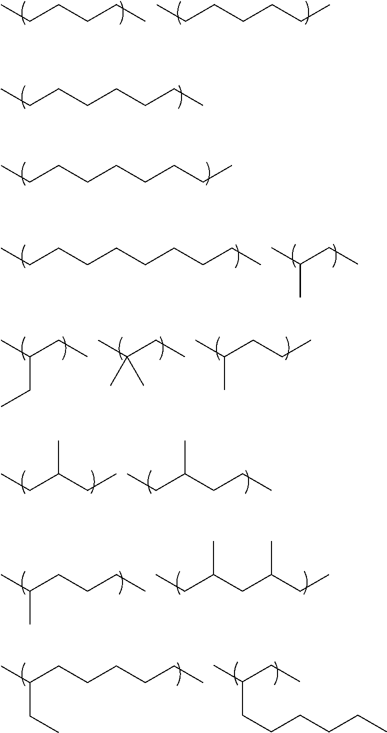

Among the above structures, more preferred structures are as follows.

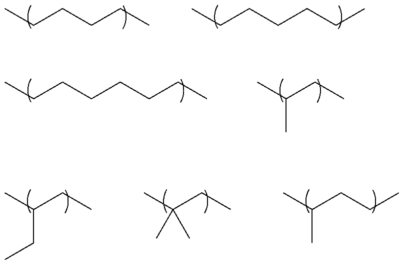

Among the above structures, even more preferred structures are as follows.

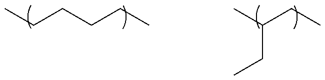

The raw material of the repeating unit of Formula (2) is not particularly limited, and examples thereof generally include an alkene having an terminal double bond. Specific examples thereof include isobutylene, 1-butene, 1-pentene, 1-hexene, 1-heptene, 1-octene, 1-nonene, 1-decene, 1,3-butadiene, 2-methyl-1,3-butadiene, 2-methyl-1,3-pentadiene, and isoprene. Among these, a compound having two conjugated double bonds is preferred from the viewpoint of crystal controllability of the polymer, 1,3-butadiene, 2-methyl-1,3-butadiene, 2-methyl-1,3-pentadiene and isoprene are more preferred, and 1,3-butadiene is even more preferred from the viewpoint of crystal controllability of the resin.

The raw material of the repeating unit of Formula (2) may be only one or two or more of the above. When a repeating unit having a plurality of double bonds is used, the remaining double bonds are converted into saturated bonds by hydrogenation after polymerization. When hydrogenation is performed 100%, only the structure of the repeating unit of the above Formula (2) is obtained, but when the hydrogenation rate is not 100%, a structure having a double bond in the main chain may be obtained. Each of the block copolymer B′ and the polymer B may contain such a repeating unit.

The content of the repeating unit of the above Formula (2) contained in the block copolymer B′ or the polymer B is not particularly limited, and is generally 5 mass % or more, preferably 10 mass % or more, and more preferably 15 mass % or more, and is generally 70 mass % or less, preferably 60 mass % or less, and more preferably 50 mass % or less.

In addition, the total content of the repeating unit of Formula (1) and the content of the repeating unit of Formula (2) in the block copolymer B′ or the polymer B is preferably 80 mass % or more, more preferably 90 mass % or more, and even more preferably 95 mass % or more.

Further, when the content (mass %) of the repeating unit of Formula (1) in the block copolymer B′ or the polymer B is defined as b1, and the content (mass %) of the repeating unit of Formula (2) in the block copolymer B′ or the polymer B is defined as b2, the b1/b2 value is not particularly limited, and is generally 0.050 or more, preferably 0.67 or more, and more preferably 1 or more, and is generally 19 or less, preferably 9.0 or less, and more preferably 7.0 or less. When the b1/b2 value is within the above range, each of the block copolymer B′ and the polymer B has appropriate crystallinity and affinity for the substrate, which is thus preferred from the viewpoints of transferability, fixability and heat resistance.

The block copolymer B′ or the polymer B may be a binary copolymer containing a repeating unit of Formula (1) and a repeating unit of Formula (2), may be a ternary copolymer further containing one optional structure, or may contain two or more optional structures.

When the polymer B is a copolymer, the polymer B may be any of a random copolymer, an alternating copolymer, a block copolymer, and a graft copolymer, and a block copolymer is preferred from the viewpoint of effectively imparting fixability and heat resistance.

When using the block copolymer B′ or the polymer B in the case of a block copolymer, it is preferable that the block copolymer B′ or the polymer B in the case of a block copolymer is a block copolymer having a polymer block P having the above Formula (1) as a repeating unit and a polymer block Q having the above Formula (2) as a polymerization unit, from the viewpoint of forming fine polymer particles in the carrier liquid by imparting appropriate crystallinity in addition to improving fixability by imparting flexibility. In addition, it is more preferable that the block copolymer B′ or the polymer B in the case of a block copolymer is a hydrogenated block copolymer in which the double bonds remaining in the precursor after polymerization are converted into saturated bonds by hydrogenation.

In the polymer block Q, the continuous presence of a linear repeating unit (Q1) contributes to the improvement of crystallinity, and on the other hand, the presence of a repeating unit (Q2) having an alkyl group in a side chain partially inhibits such crystallinity. For example, when the polymer block Q is produced from 1,3-butadiene as a raw material, by 1,4-addition polymerization and subsequent hydrogenation, a polymer composed of a linear n-butylene structural unit is obtained, and the crystallinity is increased. On the other hand, when the content ratio of a 1-ethylethylene structural unit by 1,2-addition polymerization increases, the crystallinity is decreased. Therefore, the crystallinity of the polymer can be controlled by a balance between them.

The content ratio of the linear repeating unit (Q1) to the total (Q1+Q2) of the linear repeating unit (Q1) and the repeating unit (Q2) having an alkyl group in the side chain is generally 80 mass % or more, and preferably 85 mass % or more from the viewpoint of heat resistance, and is generally 98 mass % or less, and preferably 95 mass % or less from the viewpoint of appropriate crystallinity.

The block structure of the block copolymer B′ or the polymer B in the case of a block copolymer is not particularly limited, and may be any one of linear, branched, and radial, and is preferably a block copolymer represented by the following Formula (3) or (4).

P-(Q-P)ᵣ (3)

(P-Q)ₛ (4)

(In the formulae (3) and (4), P indicates the polymer block P, Q indicates the polymer block Q, r indicates an integer of 1 or more, and s indicates an integer of 2 or more.)

From the viewpoint of ease of production, as the block copolymer, the block copolymer of the Formula (3) (a block copolymer having at least two polymer blocks P and at least one polymer block Q) is preferable to the block copolymer of the formula (4).

r indicates an integer of 1 or more, and the upper limit value is not particularly limited. From the viewpoint of ease of production, r is generally 5 or less, preferably 3 or less, and more preferably 2 or less.

s indicates an integer of 2 or more, and the upper limit value is not particularly limited. From the viewpoint of ease of production, s is generally 5 or less, preferably 4 or less, and more preferably 3 or less.

### (2-4) Method for Producing Block Copolymer B′ and Polymer B

### [Method for Producing Copolymer]

The method for producing the block copolymer B′ and the polymer B is not particularly limited. For example, a method of polymerizing a vinylcyclohexane-based monomer, a method of polymerizing a styryl-based monomer followed by nuclear hydrogenation, and the like can be mentioned.

### <Method of Polymerizing Styryl-Based Monomer Followed by Nuclear Hydrogenation>

Examples of the styryl-based monomer include styrene, α-methylstyrene, 2-methylstyrene, 3-methylstyrene, 4-methylstyrene, 2,4-dimethylstyrene, 2,4-diisopropylstyrene, 4-t-butylstyrene, 5-t-butyl-2-methylstyrene, 4-monochlorostyrene, 4-chloromethylstyrene, 4-hydroxymethylstyrene, 4-t-butoxystyrene, dichlorostyrene, 4-monofluorostyrene, and 4-phenylstyrene. Styrene, α-methylstyrene, 4-methylstyrene, 4-t-butylstyrene, 4-chloromethylstyrene and vinylnaphthalene are preferably used, and styrene, α-methylstyrene, 4-methylstyrene and 4-t-butylstyrene are more preferably used. Styrene is most preferably used. These styryl-based monomers may be used alone or in combination of two or more.

### <Nuclear Hydrogenation Method>

Hereinafter, a method for obtaining the block copolymer B′ and the polymer B by nuclear hydrogenation using a polymer before nuclear hydrogenation as a polymer C will be described.

Nuclear hydrogenation in the present description refers to hydrogenating an aromatic ring contained in the polymer C to convert the aromatic ring into a saturated hydrocarbon skeleton. Examples of the aromatic ring generally include those formed by a carbon skeleton such as a benzene ring, a naphthalene ring, and an anthracene ring. Only one type of these aromatic rings may be contained in the polymer C, or two or more types thereof may be contained in the polymer C in an optional ratio.

For example, in the case of polystyrene, the phenyl group is converted to a cyclohexyl group by nuclear hydrogenation.

When an aliphatic unsaturated hydrocarbon (olefin) moiety is contained in an optional moiety in the polymer skeleton, this moiety may become a saturated hydrocarbon moiety at the same time as nuclear hydrogenation. In this case, the moiety corresponds to the repeating unit of the above Formula (2).

The nuclear hydrogenation rate is not particularly limited, and is generally 5 mol % or more, preferably 50 mol % or more, more preferably 70 mol % or more, even more preferably 80 mol % or more, particularly preferably 95 mol % or more, and most preferably 99 mol % or more, among the aromatic ring contained in the polymer C. The upper limit is not particularly limited. When the nuclear hydrogenation rate is within the above range, the fixability of the developer using the obtained hydrogenated copolymer tends to be improved. The nuclear hydrogenation rate can be calculated by using, for example, ¹H-NMR from the integrated value of the peak derived from an aliphatic substance in the vicinity of 0.5 ppm to 2.5 ppm and the peak derived from an aromatic substance in the vicinity of 6.0 ppm to 8.0 ppm.

The nuclear hydrogenation method is not particularly limited, and for example, there is a method of hydrogenating an aromatic ring in the presence of a catalyst, hydrogen, or the like. Pressurization or heating may be performed if necessary.

A specific nuclear hydrogenation method will be described below.

### (Catalyst)

A catalyst may be used for nuclear hydrogenation, and a metal catalyst can be used as the catalyst. Examples of the metal catalyst include an alloy catalyst, and a supported metal catalyst in which an active metal species is supported on a supporter.

The metal component of the metal catalyst is not particularly limited as long as it can hydrogenate the aromatic ring in the vinyl aromatic copolymer, and generally, metals such as ruthenium, nickel, copper, palladium, gold, platinum, iron, osmium, cobalt, rhodium and iridium can be used. Among these, it is preferable to contain at least one metal element selected from the group consisting of Group 8, Group 9, Group 10 and Group 11 in the long form of the periodic table as those exhibiting the hydrogenation ability. Particularly from the viewpoint of a high hydrogenation ability, it is preferable to contain at least one metal element selected from the group consisting of Group 8, Group 9, and Group 10 in the long form of the periodic table. Particularly from the viewpoint of selectivity, ruthenium, rhodium, nickel, palladium or platinum are preferred, and particularly from the viewpoint of a high ability for nuclear hydrogenation, ruthenium, nickel or palladium is preferred.

As the metal catalyst to be used in nuclear hydrogenation, one kind of the above-mentioned metals may be used, or two or more kinds thereof may be used. When two or more kinds of metals are used, the combination thereof is not particularly limited, and one (cocatalysts) in which each metal has catalytic activity or one (promotor) which improves a catalytic activity of one or more metals may be used, and a promotor is preferred.

The alloy catalyst is not particularly limited, and an alloy of metals such as ruthenium, nickel, copper, palladium, gold, and platinum is used. Specific examples thereof include generally known Raney catalysts and copper chromium catalysts.

The metal catalyst may be a supported metal catalyst in which an active metal species is supported on various supporters described later, and it is preferable to use a supported metal catalyst because the supported metal catalyst can be easily separated from the reaction solution and the catalyst can be easily reused.

The supporter is not particularly limited, and examples thereof include carbon-based supporters such as activated carbon, carbon black, and silicon carbide, and metal oxide supporters such as alumina, silica, zirconia, niobia, titania, ceria, diatomaceous earth, and zeolite. Among these, it is preferable to use at least one selected from the group consisting of activated carbon, silica and alumina as a supporter in terms of exhibition of reaction activity and stabilization of catalyst activity.

The content of the metal in the supported metal catalyst is not particularly limited, and is generally 0.5 mass % or more, and preferably 1 mass % or more, based on the total mass of the supporter and the metal, in terms of mass percentage converted into metal. The content of the metal in the supported metal catalyst is generally 50 mass % or less, preferably 20 mass % or less, and more preferably 10 mass % or less. When the content of the metal is within the above range, sufficient catalytic activity can be obtained. In the above description of the catalyst, the value described as mass % indicates the content of the metal with respect to the total mass of the supporter and the metal in the catalyst.

The specific surface area of the supporter to be used for the supported metal catalyst is not particularly limited, and is generally 1 m²/g or more, preferably 10 m²/g or more, and more preferably 50 m²/g or more. The specific surface area of the supporter to be used for the supported metal catalyst is preferably 2,000 m²/g or less, more preferably 1,500 m²/g or less, and still more preferably 1,000 m²/g or less.

When a specific surface area equal to or larger than the lower limit value is used, it is possible to support the metal on the supporter with a high degree of dispersion, which is preferred in obtaining sufficient catalytic activity. Further, it is preferable to use a metal catalyst having a specific surface area equal to or less than the upper limit value from the viewpoint that pores normally contained in the supporter can be effectively used.

The average pore size of the supporter to be used for the supported metal catalyst is not particularly limited, and is generally 200 Å or more, and preferably 250 Å or more. The average pore size of the supporter to be used for the supported metal catalyst is preferably 1,000 Å or less, and more preferably 600 Å or less.

When the average pore size is equal to or larger than the lower limit, the polymer C is sufficiently incorporated, and the treatment efficiency tends to be maintained. Although a supporter having an average pore diameter larger than the upper limit can be used, the average pore size is preferably equal to or less than the upper limit from the viewpoint of effectively using the supporter surface.

The shape of the metal catalyst to be used in nuclear hydrogenation is not particularly limited, and can be appropriately selected and used according to the type of reaction carried out using the metal catalyst. Specific shapes of the metal catalyst include, for example, powder, particle, or pellet, and among these, powder, which is less influenced by intrapore diffusion, is preferred.

Further, an average particle diameter of the metal catalyst to be used in nuclear hydrogenation is not particularly limited. The average particle diameter can be appropriately selected depending on the type of reaction using the metal catalyst, and is generally 30 μm or more and 20 mm or less.

The average particle diameter of the metal catalyst can be obtained by dynamic light scattering.

The amount of the metal catalyst to be used in nuclear hydrogenation is not particularly limited as long as the aromatic ring can be hydrogenated within an appropriate time, and is generally 0.01 mass % or more, preferably 0.1 mass % or more, and more preferably 1 mass % or more, with respect to the mass of the polymer C. The amount of the metal catalyst to be used is preferably 50 mass % or less, more preferably 20 mass % or less, and still more preferably 10 mass % or less, with respect to the mass of the polymer C.

### (Reaction Conditions in Nuclear Hydrogenation)

Nuclear hydrogenation may be carried out in a hydrogen atmosphere. The hydrogen source is not particularly limited, and it is desirable to use gaseous hydrogen which does not need to be separated and purified after completion of the reaction.

The nuclear hydrogenation reaction is generally carried out under pressurized conditions with hydrogen gas. The pressure in the nuclear hydrogenation reaction is not particularly limited, and is generally 1 MPa or more, preferably 3 MPa or more, and more preferably 5 MPa or more. The pressure in the nuclear hydrogenation reaction is preferably 30 MPa or less, more preferably 20 MPa or less, and even more preferably 15 MPa or less.

Generally, when the reaction pressure is increased, the supply of hydrogen to the metal catalyst is promoted and the reaction rate of nuclear hydrogenation is improved. On the other hand, in order to carry out nuclear hydrogenation at a high reaction pressure, equipment such as a reactor with specially increased pressure resistance is required, and there is a possibility that a decomposition reaction of the copolymer may occur under the condition of a high reaction pressure.

The hydrogen concentration of the hydrogen gas in a hydrogen atmosphere is not particularly limited, and is generally 70 vol % or more, preferably 80 vol % or more, and more preferably 90 vol % or more. The upper limit is generally 100 vol % or less, and preferably 95 vol % or less.

The temperature at which the polymer C is nuclear hydrogenated is not particularly limited, and is generally 20° C. or higher, preferably 50° C. or higher, more preferably 90° C. or higher, and even more preferably 150° C. or higher. The temperature at which the polymer C is nuclear hydrogenated is preferably 300° C. or lower, more preferably 250° C. or lower, and even more preferably 220° C. or lower. When the reaction temperature is within above range, efficient nuclear hydrogenation tends to be achieved with preventing the decomposition reaction of the copolymer.

The reaction time for nuclear hydrogenation of the polymer C is not particularly limited as long as the nuclear hydrogenation of the copolymer is achieved. The reaction time is preferably 30 minutes or longer, and more preferably 1 hour or longer, and is preferably 24 hours or shorter, and more preferably 12 hours or shorter.

A solvent may be used in nuclear hydrogenation. The solvent is not particularly limited, and examples thereof include: alcohols such as methanol, ethanol, 1,4-butanediol, 2,3-butanediol, 1,2-butanediol, and 1,3-butenediol; ethers such as tetrahydrofuran (THF), dioxane, diethylene glycol dimethyl ether, and triethylene glycol dimethyl ether; and hydrocarbons such as hexane, cyclohexane, and decalin. These solvents may be used alone or as a mixed solvent of two or more types thereof. From the viewpoint of the solubility of the polymer C, tetrahydrofuran (THF) or cyclohexane is preferably used as the solvent.

When a solvent is used in nuclear hydrogenation, the concentration of the polymer C in the solvent is not particularly limited, and is generally 5 mass % or more, preferably 10 mass % or more, and more preferably 15 mass % or more. The concentration of the polymer C in the solvent is preferably 70 mass % or less, and more preferably 50 mass % or less. When the concentration of the polymer C is within the above range, there is a tendency that an increase in viscosity of the reaction solution of the polymer C can be prevented and the handleability of the reaction solution can be maintained while the productivity is maintained.

### (Reaction Apparatus)

The reaction apparatus to be used in nuclear hydrogenation is not particularly limited, and an autoclave enabling a high pressure reaction is generally used. A loop reactor may also be used. A continuous reactor can also be used, and the reactor can be filled with a catalyst, and the raw material liquid and hydrogen can be circulated to carry out the reaction. When a continuous reactor is used, a catalyst separation step is not required, so that a continuous reactor is preferred for mass production.

As the material of the reaction apparatus, SUS (stainless steel) is generally used, and acid resistant SUS such as Hastelloy may be used. As a countermeasure against the generated acid, a glass lining container, a Teflon (registered trademark)—coated container, or the like can also be used.

### (Catalyst Separation)

After nuclear hydrogenation, the catalyst may be separated from the resulting hydrogenated copolymer. The specific method for separating the catalyst is not particularly limited, and examples thereof include filtration with a filter, decantation, and centrifugation.

The resulting copolymer may be very difficult to filter due to a branched structure thereof. In this case, separation by decantation or centrifugation is particularly desirable.

### <Method for Producing Block Copolymer>

The production (polymerization) of the block copolymer is generally carried out by using a living anionic polymerization method using an organic solvent. As a general method for producing a block copolymer by anionic polymerization, after completion of the polymerization of a monomer such as styrene, a method of sequentially adding a different monomer such as butadiene and isoprene, and a method of coupling a living polymer of a styrene-butadiene diblock copolymer having an anionic terminal are known.

(3) Mixing Ratio of Ethylene-(Meth)Acrylic Acid Copolymer a and Block Copolymer B′ or polymer B

The mixing ratio of the ethylene-(meth)acrylic acid copolymer A and the block copolymer B′ or the polymer B is not particularly limited. The content of the block copolymer B′ or the polymer B is generally 5 mass % or more, preferably 7 mass % or more, and more preferably 10 mass % or more, and is generally 50 mass % or less, preferably 40 mass % or less, and more preferably 30 mass % or less, with respect to the total amount of the ethylene-(meth)acrylic acid copolymer A and the block copolymer B′ or the polymer B. The above content is preferred from the viewpoint of achieving both heat resistance and fixability.

The mechanism of the synergistic effect on fixability and heat resistance due to the coexistence of the ethylene-(meth)acrylic acid copolymer A and the block copolymer B′ or the polymer B can be estimated as follows.

The ethylene-(meth)acrylic acid copolymer A has a carboxyl group, which is a polar group, and thus has a high affinity for and excellent fixability to a polar printing medium such as polyester and nylon.

On the other hand, the block copolymer B′ or the polymer B has a flexible and low-polarity alicyclic hydrocarbon group, and thus has a high affinity for and excellent fixability to a low polarity printing medium such as polyethylene and polypropylene. It is presumed that the reason for this is that the alicyclic hydrocarbon group and the low crystal portion of the printing medium are structurally similar at a macromolecular aggregate level. It is considered that, in this case, particularly the presence of the alicyclic hydrocarbon group in the side chain portion promotes molecular-level approach to the printing medium and to be eutectic, by which the affinity for the printing medium is increased. Therefore, even when the main chain portion has an alicyclic hydrocarbon group, the affinity for the printing medium is not sufficiently exhibited.

In addition, when the main chain portion of the block copolymer B′ or the polymer B has an alicyclic hydrocarbon group, the structure is too rigid and the affinity for the solvent is low. Therefore, from the viewpoint of producing a liquid developer, it is inferior to the case where the alicyclic hydrocarbon group is present in the side chain portion. However, it does not mean that the block copolymer B′ or the polymer B having an alicyclic hydrocarbon group in the main chain portion is excluded.

In addition, the ethylene-(meth)acrylic acid copolymer A is not completely incompatible with the block copolymer B′, and the ethylene-(meth)acrylic acid copolymer A is not completely incompatible with the polymer B, which are considered to have an appropriate microphase separation structure. Therefore, it is considered that, depending on the type of the printing medium, components which are more likely to exhibit fixability are easily exposed at the interface of the printing medium in an appropriate area and are to be fixed on a wide variety of printing media. Further, it is expected that the block copolymer B′ and the polymer B exhibiting heat resistance are “islands” and the ethylene-(meth)acrylic acid copolymer A is “sea” in microphase separation. Therefore, it is considered that, after the carrier liquid has volatilized to form a printing layer, the block copolymer B′ or the polymer B is phase-separated and localized at the interface between the printing surface and the printing medium, so that the heat resistance is more easily exhibited.

In particular, the block structure of the block copolymer B′ and the block structure of the polymer B in the case of a block copolymer are considered to be advantageous in forming a microphase separation structure because appropriate crystallinity is imparted to the copolymer. If the block copolymer B′ or the polymer B in the case of a block copolymer forms a microphase separation structure, it can be expected to improve the affinity for the ethylene-(meth)acrylic acid copolymer A.

### <Other Components>

### (Colorant)

The liquid developer of the present invention may contain a colorant, if necessary. Examples of the colorant include: pigments such as Carbon Black, Chrome Yellow, Hansa Yellow, Benzidine Yellow, Slene Yellow, Quinoline Yellow, Pigment Yellow, Permanent Orange GTR, Pyrazolone Orange, Balkan Orange, Watch Young Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Chalco oil Blue, Methylene Blue Chloride, Phthalocyanine Blue, Pigment Blue, Phthalocyanine Green, and Malachite Green Oxalate; and acridine, xanthene, azo, benzoquinone, azine, anthraquinone, thioindico, dioxazine, thiazine, azomethine, indico, phthalocyanine, aniline black, polymethine, triphenylmethane, diphenylmethane, and thiazole dyes. The colorants may be used alone or in combination of two or more thereof.

As the colorant, a surface-treated colorant may be used if necessary, or the colorant may be used in combination with a dispersant. In addition, a plurality of types of colorants may be used in combination.

When a colorant is used, the content of the colorant is not particularly limited, and is generally 1 mass % or more, and preferably 3 mass % or more, and is generally 60 mass % or less, preferably 50 mass % or less, and more preferably 35 mass % or less, with respect to the developer component.

### (Charge Control Agent)

The liquid developer of the present invention may contain a charge control agent, if necessary. The charge control agent is not particularly limited, and a known charge control agent is used. Examples thereof include: positive charge control agents such as a nigrosine dye, a fatty acid-modified nigrosine dye, a fatty acid-modified nigrosine dye containing a carboxyl group, a quaternary ammonium salt, an amine compound, an amide compound, an imide compounds, and an organometallic compound; and negative charge control agents such as a metal complex of oxycarboxylic acids, a metal complex of azo compounds, a metal complex salt dye, and a salicylic acid derivative. These charge control agents may be used alone or in combination of two or more thereof. In addition, a part of the charge control agents may be contained in the developer particles as an auxiliary charge agent, and other charge control agents may be appropriately mixed with the developer in a printing machine as a solution.

### (Wax)

The liquid developer of the present invention may contain a wax, if necessary. The wax is not particularly limited, and examples thereof include: vegetable waxes such as carnauba wax, sugar wax, and wood wax; animal waxes such as beeswax, insect wax, whale wax, and wool wax; and synthetic hydrocarbon waxes such as Fisher Tropsch wax (FT wax), polyethylene wax, polypropylene wax, and polyester wax, which have an ester in the side chain. These waxes may be used alone or in combination of two or more thereof

### (Other Additives)

The liquid developer of the present invention may contain one or more additives other than the above components, such as a surfactant, a bactericide, a viscosity regulator, a pH regulator, a preservative, a compatibilizer, and an emulsifier.

### <Method for Producing Liquid Developer>

Although an example of a method for producing a liquid developer is shown below, the method is not limited to the following method, and can be appropriately modified and applied.

### (Production of Polymer Paste)

The ethylene-(meth)acrylic acid copolymer A, the block copolymer B′ or the polymer B, and if necessary, a resin wax and the like are charged together with a carrier liquid into a container having a planetary mixer or a full zone stirring blade. Then, the internal temperature is raised to about 120° C. under stirring, and after reaching 120° C., the mixture is stirred for a certain period of time with maintaining the temperature. Thereafter, stirring is continued with allowing the internal temperature to be slowly lowered to become about 25° C. and a polymer paste is produced.

### (Production of Liquid Developer)

Next, the above polymer paste, and if necessary, a colorant, an auxiliary charge agent, and a wax, are charged into an attritor together with beads (for example, stainless steel beads) for crushing and a carrier liquid for dilution, and wet crushing is performed if necessary with controlling the internal temperature. The obtained product is mesh-filtered to remove beads and a liquid developer is produced.

The average particle diameter of particles contained in the liquid developer is not particularly limited, and is generally 0.3 μm or more, preferably 0.5 μm or more, and more preferably 0.8 μm or more, and is generally 10 μm or less, preferably 8 μm or less, and more preferably 5 μm or less. Further, the particle size distribution of the particles contained in the liquid developer is preferably one mountain and close to monodisperse.

The average particle diameter of the particles contained in the liquid developer can be obtained by a dynamic light scattering method.

### [2] Image Forming Method, Liquid Developer Cartridge, and Image Forming Apparatus

The liquid developer of the present invention is to be used, for example, in an electrophotographic image forming apparatus of the present invention as shown in the FIGURE. Digital image data of a computer 100 is converted into an optical pattern by an exposure device 102, and a photoreceptor 105 uniformly charged by a charging device 101 is irradiated. On an electrostatic latent image formed thereby, a developer supplied from a developer tank 103 is developed on the photoreceptor 105 by a developing device 104. The developer developed on the photoreceptor 105 is primarily transferred to an intermediate transfer body 107 by an electrostatic force. After the developer is transferred to the intermediate transfer body 107, the excess developer is removed from the photoreceptor 105 by a cleaning device 106, and the process proceeds to the next image formation.

The developer containing a carrier liquid primary transferred from the photoreceptor 105 onto the intermediate transfer body 107 is dried and melted by an internal heater 109 and an external heater 108 of the intermediate transfer body 107, and secondarily transferred and fixed on a printing medium 111 such as a film by a pressure roller 110, thereby forming a desired image on the printing medium 111.

In this image forming apparatus, a part of these processes, such as the charging device 101, the developing device 104, the photoreceptor 105 and the cleaning device 106, may be removed and replaced as an integral liquid developer cartridge of the present invention.

The carrier liquid used in the image forming apparatus of the present invention may be collected and reused in the image forming apparatus. Further, the photoreceptor 105 and the intermediate transfer body 107 may have a sheet shape which can be removed and replaced with a cylindrical substrate.

### EXAMPLES

Hereinafter, embodiments of the present invention will be described in more detail with reference to Examples. However, the following Examples are given to describe the invention in detail, and the present invention is not limited to the Examples described below and can be optionally modified and implemented without departing from the gist of the present invention.

### <Block Copolymer B′ or Polymer B>

Using a styrene-butadiene-styrene block copolymer, the following copolymers MC-1 and MC-2 were obtained by the method described in paragraphs [0084] to [0087] in JP-A-2014-019789. The polymers used in Examples are as follows.

### [MC-1]

A [P]-[Q]-[P]-[Q]-[P] pentablock copolymer containing a repeating unit of the following P, a repeating unit of the following Q1, and a repeating unit of the following Q2, and having a mass ratio of [repeating unit of P]:[repeating of Q1]:[repeating unit of Q2]=84.4:14.4:1.2, in which a block composed of a polymer containing the repeating units of P is represented as [P] and a block composed of a polymer containing the repeating units of Q1 and Q2 is represented as [Q].

MFR [measurement temperature: 230° C., load: 2.16 kg (ISO R1133)]: 1.3 g/10 min

Glass transition temperature (Tg): 129° C.

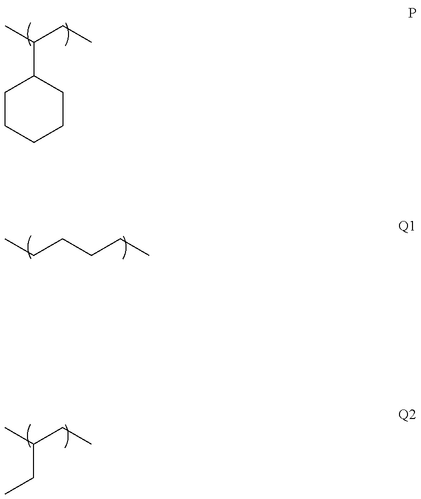

### [MC-2]

A [P]-[Q]-[P]-[Q]-[P] pentablock copolymer containing a repeating unit of the above P, a repeating unit of the above Q1, and a repeating unit of the above Q2, and having a mass ratio of [repeating unit of P]:[repeating unit of Q1]: [repeating unit of Q2]=81.7:16.3:1.9, in which a block composed of a polymer containing the repeating units of P is represented as [P] and a block composed of a polymer containing the repeating units of Q1 and Q2 is represented as [Q].

MFR [measurement temperature: 230° C., load: 2.16 kg (ISO R1133)]: 35 g/10 min

Glass transition temperature (Tg): 110° C.

### [MC-3]

Using a styrene-isobutylene-styrene triblock polymer (SIBSTAR (registered trademark) S103T manufactured by KANEKA CORPORATION, styrene: 30 mass %, Mn=100,000), nuclear hydrogenation was carried out by the method described in paragraphs [0084] to [0087] in JP-A-2014-019789 to obtain a copolymer MC-3. (hydrogenation rate: 99.0%)

Glass transition temperature (Tg): 132° C.

### Example 1

### <Production of Polymer Paste>

Into a planetary mixer (trade name: PLM-2, manufactured by INOUE MFG., INC.), 100 g of a poly(ethylene-methacrylic acid) copolymer (trade name: N1050H, manufactured by DuPont-Mitsui Polychemicals Co. Ltd.), 100 g of a poly(ethylene-acrylic acid) copolymer (trade name: AC-5120, manufactured by Honeywell Japan Ltd.), 50 g of MC-1, and 380 g of an isoparaffin-based solvent (trade name: ISOPAR L, manufactured by Exxon Mobil Corporation) were charged. Then, the internal temperature was raised to 120° C. over 1 hour with stirring at 30 rpm for revolution and 90 rpm for rotation, and after reaching 120° C., the mixture was stirred for 1.5 hours with maintaining the temperature. Thereafter, stirring was continued with lowering the internal temperature to 25° C. over 4 hours to produce a polymer paste.

### <Production of Liquid Developer>

Next, 92.3 g of the above polymer paste, 9.5 g of carbon black (trade name: Mitsubishi Carbon Black #960, manufactured by Mitsubishi Chemical Corporation), 0.60 g of aluminum tristearate (manufactured by NOF Corporation), 3.0 g of a polyethylene wax (trade name: ACumist B-6, manufactured by Honeywell Japan Ltd.), and 145 g of an isoparaffin-based solvent (trade name: ISOPAR L, manufactured by Exxon Mobil Corporation) together with 2 kg of stainless steel beads having a diameter of 5 mm were charged into an attritor (trade name: MA01SC, manufactured by NIPPON COKE & ENGINEERING. CO., LTD.). Then, an internal temperature was allowed to be raised to be 58° C., and the mixture was stirred and crushed at a rotation speed of 30 rpm for 1.5 hours. Further, the internal temperature was allowed to be lowered to be 36° C., and the mixture was stirred and crushed for 3.5 hours. The obtained dispersion liquid is mesh-filtered, to produce a liquid developer.

### <Fixability Test 1>

Using a wire bar No. 6, the obtained liquid developer was coated onto a biaxially stretched polypropylene film (abbreviated as OPP, film thickness: 20 pin) for which pre-corona treatment had been carried out and drying was performed at 120° C. for 10 minutes. Then, a fluororesin sheet was placed on the coated surface and a pressure heat treatment was carried out by being passed through a laminator (trade name: Proteus A3, manufactured by Fellowes) at 120° C. The fluororesin sheet was peeled off from the surface coated by the liquid developer and cooling was carried out to room temperature. On the next day, a tape (trade name: Masking Tape 234, manufactured by 3M) was attached to the surface of the liquid developer and peeled off in the 180 degree direction to evaluate the fixability between the liquid developer and the film. Further, the same evaluation was performed using a biaxially stretched polyethylene terephthalate film (abbreviated as OPET, film thickness: 12 μm) instead of the above OPP. The results are shown in Table 1.

### <Fixability Test 2>

The obtained liquid developer was sealed in a liquid developer can of an electrophotographic liquid developer printing machine (trade name: Indigo WS6600, manufactured by Hewlett-Packard Company) and installed on a liquid developer station. Then, without using a primer, the liquid developer was printed directly on a biaxially stretched polypropylene film (abbreviated as OPP, film thickness: 20 μm) for which pre-corona treatment had been carried out. On the next day after printing, a tape (trade name: Masking Tape 234, manufactured by 3M) was attached to the surface of the liquid developer and peeled off in the 180 degree direction to evaluate the fixability between the liquid developer and the film. Further, the same evaluation was performed using a biaxially stretched polyethylene terephthalate film (abbreviated as OPET, film thickness: 12 μm) instead of the above OPP. The results are shown in Table 1.

In the fixability tests 1 and 2, the degree of fixability was evaluated on the following five stages wherein 3 or more indicates an acceptable level, and 1 and 2 indicate an unacceptable level.

5: There is no peeling on the part where the tape is attached.

4: There is a dot-like peeling on the part where the tape is attached.

3: There is a peeling that some dots are connected to the part where the tape is attached.

2: There is a peeling on about half of the area of the part where the tape is attached.

1: There is an overall peeling on the part where the tape is attached.

### <Heat Resistance Test>

The same printing film used in the fixability test 2 was sandwiched between two glass plates having 1 cm thickness with a state that the printed surface and a paper (HQ-500 obtained from NP Trading Co., Ltd.) are in contact with each other, followed by heating in an oven at 120° C. for 5 minutes. After cooling, the paper was peeled off from the film and the degree of migration of the liquid developer to the paper was examined. A larger degree of migration of the liquid developer means lower heat resistance, indicating that the liquid developer is melted during heating.

In the heat resistance test, the degree of heat resistance was evaluated in the following three stages wherein 2 or more indicates an acceptable level, and 1 indicates an unacceptable level.

3: There is no migration of the liquid developer.

2: There is migration of the liquid developer thinly in dots

1: There is migration of the thick liquid developer.

### Example 2

The production of the polymer paste, the production of the liquid developer, and the fixability test 1, the fixability test 2, and the heat resistance test were performed in the same manner as in Example 1, except that MC-2 was used instead of MC-1. The results are shown in Table 1.

### Example 3

The production of the liquid developer, and the fixability test 1, the fixability test 2, and the heat resistance test were performed in the same manner as in Example 1, except that the method for producing a polymer paste was changed as follows. The results are shown in Table 1.

### <Production of Polymer Paste>

Into a planetary mixer (trade name: PLM-2, manufactured by INOUE MFG., INC.), 56 g of a poly(ethylene-methacrylic acid) copolymer (trade name: N1050H, manufactured by DuPont-Mitsui Polychemicals Co. Ltd.), 169 g of a poly(ethylene-acrylic acid) copolymer (trade name: AC-5120, manufactured by Honeywell Japan Ltd.), 25 g of MC-1, and 380 g of an isoparaffin-based solvent (trade name: ISOPAR L, manufactured by Exxon Mobil Corporation) were charged. Then, an internal temperature was allowed to be raised to 120° C. over 1 hour with stirring at 30 rpm for revolution and 90 rpm for rotation, and after reaching 120° C., the mixture was stirred for 1.5 hours with maintaining the temperature. Thereafter, stirring was continued with lowering the internal temperature to 25° C. over 4 hours to produce a polymer paste.

### Example 4

The production of the polymer paste, the production of the liquid developer, and the fixability test 1, the fixability test 2, and the heat resistance test were performed in the same manner as in Example 3, except that MC-2 was used instead of MC-1. The results are shown in Table 1.

### Example 5

The production of the polymer paste, the production of the liquid developer, and the fixability test 1, the fixability test 2, and the heat resistance test were performed in the same manner as in Example 1, except that MC-3 was used instead of MC-1. The results are shown in Table 1.

### Comparative Example 1

The production of the liquid developer, and the fixability test 1, the fixability test 2, and the heat resistance test were performed in the same manner as in Example 1, except that the method for producing a polymer paste was changed as follows. The results are shown in Table 1.

### <Production of Polymer Paste>

Into a planetary mixer (trade name: PLM-2, manufactured by INOUE MFG., INC.), 200 g of a poly(ethylene-methacrylic acid) copolymer (trade name: N1110H, manufactured by DuPont-Mitsui Polychemicals Co. Ltd.), 50 g of a poly(ethylene-acrylic acid) copolymer (trade name: AC-5120, manufactured by Honeywell Japan Ltd.), and 380 g of an isoparaffin-based solvent (trade name: ISOPAR L, manufactured by Exxon Mobil Corporation) were charged. Then, an internal temperature was raised to 120° C. over 1 hour with stirring at 30 rpm for revolution and 90 rpm for rotation, and after reaching 120° C., the mixture was stirred for 1.5 hours with maintaining the temperature. Thereafter, stirring was continued with lowering the internal temperature to 25° C. over 4 hours to produce a polymer paste.

### Comparative Example 2

The production of the liquid developer, and the fixability test 1, the fixability test 2, and the heat resistance test were performed in the same manner as in Comparative Example 1, except that a polyethyleneimine aqueous solution was previously coated onto OPP and OPET, dried to form a primer layer having 0.1 μm thickness, and then a liquid developer was used for coating and printing. The results are shown in Table 1.

### Comparative Example 3

The production of a polymer paste was performed in the same manner as in Example 1 except that a polymer R1 having a repeating unit of the following formula was used instead of MC-1. Since large agglomerates and coarse particles which were difficult to crush were generated, a good polymer paste could not be produced, and a liquid developer could not be produced.

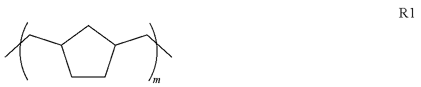

In the above formula, m represents an integer of 1 or more.

### Comparative Example 4

The production of a polymer paste was performed in the same manner as in Example 1 except that a block copolymer R2 having a repeating unit of the following formula was used instead of MC-1. Since large agglomerates and coarse particles which were difficult to crush were generated, a good polymer paste could not be produced, and a liquid developer could not be produced.

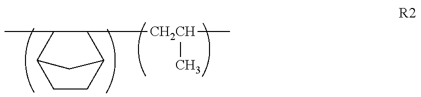

### Comparative Example 5

A block copolymer R3 having a repeating unit of P′ below was used instead of the repeating unit of P in MC-1 in Example 1. Since the block copolymer R3 was dissolved in the carrier liquid, an appropriate polymer paste could not be produced, and a liquid developer could not be produced.

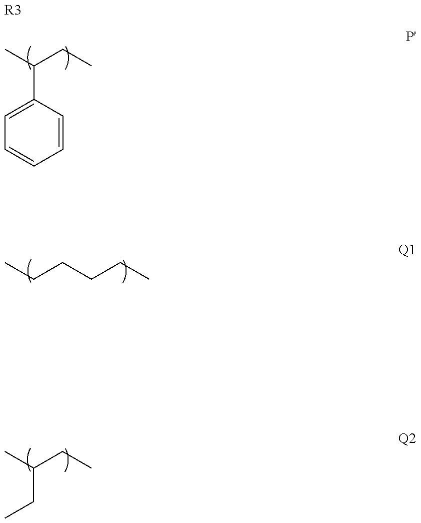

### Comparative Example 6

A block copolymer R4 consisting of a repeating unit of the following P′, a repeating unit of Q1′, and a repeating unit of Q2′, which were not hydrogenated, was used instead of the repeating unit of P and the repeating unit of Q in MC-1 in Example 1. Since the block copolymer R4 was dissolved in the carrier liquid, an appropriate polymer paste could not be produced, and a liquid developer could not be produced.

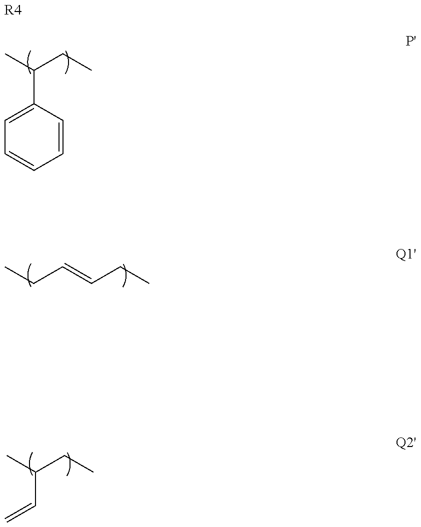

### Comparative Example 7

### <Production of Polymer Paste>

Into a planetary mixer (trade name: PLM-2, manufactured by INOUE MFG., INC.), 75 g of MC-1 and 300 g of an isoparaffin-based solvent (trade name: ISOPAR L, manufactured by Exxon Mobil Corporation) were charged. Then, an internal temperature was raised to 120° C. over 1 hour with stirring at 30 rpm for revolution and 90 rpm for rotation, and after reaching 120° C., the mixture was stirred for 1.5 hours with maintaining the temperature. Thereafter, stirring was continued with lowering the internal temperature to 25° C. over 4 hours to produce a polymer paste.

### <Production of Liquid Developer>

Although an attempt was made to produce a liquid developer in the same manner as in Example 1, carbon black aggregated and the liquid developer could not be produced.

TABLE 1

| | Content of each polymer in all | | | | | | |
|---|---|---|---|---|---|---|---|
| | polymers in liquid developer | | | | | | Heat |
| | | Polymer | Other | Printing | Fixability | Fixability | resistance |
| | Polymer A | B | Polymer | film | test 1 | test 2 | test |
| Example 1 | 80 mass % | 20 mass % | — | OPP | 4 | 4 | 3 |
| | | (MC-1) | | OPET | 4 | 3 | 3 |
| Example 2 | 80 mass % | 20 mass % | — | OPP | 4 | 4 | 3 |
| | | (MC-2) | | OPET | 4 | 3 | 3 |
| Example 3 | 90 mass % | 10 mass % | — | OPP | 5 | 5 | 3 |
| | | (MC-1) | | OPET | 4 | 4 | 3 |
| Example 4 | 90 mass % | 10 mass % | — | OPP | 5 | 5 | 3 |
| | | (MC-2) | | OPET | 4 | 4 | 3 |
| Example 5 | 80 mass % | 20 mass % | — | OPP | 3 | 3 | 2 |
| | | (MC-3) | | OPET | 3 | 3 | 2 |
| Comparative | 100 | — | — | OPP | Non- | Non- | Non- |
| Example 1 | mass % | | | | printable | printable | printable |
| | | | | OPET | 2 | 2 | 1 |
| Comparative | 100 | — | — | OPP | 5 | 5 | 1 |
| Example 2 | mass % | | | OPET | 4 | 4 | 1 |

| | | | | |
|---|---|---|---|---|
| Comparative | 80 mass % | — | 20 mass % | Liquid developer could not be produced. |
| Example 3 | | | (R1) | |
| Comparative | 80 mass % | | 20 mass % | Liquid developer could not be produced. |
| Example 4 | | | (R2) | |
| Comparative | 80 mass % | — | 20 mass % | Liquid developer could not be produced. |
| Example 5 | | | (R3) | |
| Comparative | 80 mass % | — | 20 mass % | Liquid developer could not be produced. |
| Example 6 | | | (R4) | |
| Comparative | — | 100 | — | Liquid developer could not be produced. |
| Example 7 | | mass % | | |
| | | (MC-1) | | |

As seen from Table 1, the liquid developer of the present invention containing the ethylene-(meth)acrylic acid copolymer A and the block copolymer B′ or the polymer B has good fixability and heat resistance (Examples 1 to 5).

On the other hand, a liquid developer containing only the ethylene-(meth)acrylic acid copolymer A without containing the block copolymer B′ or the polymer B causes poor transfer to the film (related to poor fixability to the film) and insufficient heat resistance.

Specifically, in Comparative Example 1 in which the primer layer was not formed, the level of transferability required for printing could not be obtained, and printing was impossible. In Comparative Example 2 in which the primer layer was formed, printing was possible, but heat resistance was insufficient.

In addition, in case of a liquid developer containing only the block copolymer B′ or the polymer B without containing the ethylene-(meth)acrylic acid copolymer A, poor dispersion of pigments occurred in production of a liquid developer, and a good liquid developer could not be produced.

Although the present invention has been described in detail with reference to specific embodiments, it will be apparent to those skilled in the art that various changes and modifications are possible without departing from the spirit and scope of the present invention. The present application is based on a Japanese Patent Application (Japanese Patent Application No. 2019-123721) filed on Jul. 2, 2019, contents of which are incorporated herein by reference.

### INDUSTRIAL APPLICABILITY

The liquid developer of the present invention has a wide range of industrial applicability in the technical field of the liquid developing method, which is one of the electrophotographic methods. The liquid developer of the present invention can be adopted in a multifunction device having at least two functions selected from the group consisting of a printer, a printing machine, a copying machine and a facsimile machine, or a multifunction device having at least one function selected from the above group and other functions.

### REFERENCE SIGNS LIST

100 computer
101 charging device
102 exposure device
103 developer tank
104 developing device
105 photoreceptor
106 cleaning device
107 intermediate transfer body
108 external heater
109 internal heater
110 pressure roller
111 printing medium

1. A liquid developer comprising a carrier liquid and a developer component,
wherein the developer component comprises an ethylene-(meth)acrylic acid copolymer A and a block copolymer B′ comprising a hard segment and a soft segment, and
the hard segment is a vinyl alicyclic hydrocarbon polymer.

2. The liquid developer according to claim 1, wherein the block copolymer B′ has a repeating unit of the following Formula (1): 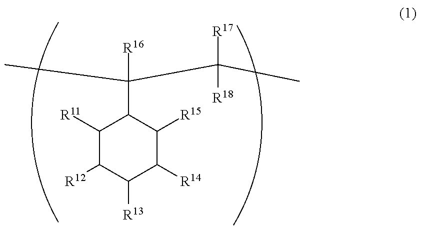
wherein, in Formula (1), R¹¹ to R¹⁸ each independently represent a hydrogen atom, a halogen atom, a hydrocarbon group, or an alkoxy group.

3. The liquid developer according to claim 1, wherein a content of the block copolymer B′ is 5 mass % or more and 50 mass % or less with respect to a total amount of the ethylene-(meth)acrylic acid copolymer A and the block copolymer B′.

4. The liquid developer according to claim 1, wherein the block copolymer B′ further comprises a repeating unit of the following Formula (2): 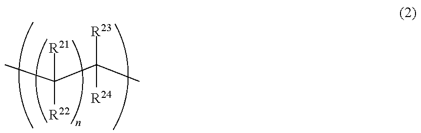
wherein, in Formula (2), R²¹ to R²⁴ each independently represent a hydrogen atom, a halogen atom, a hydrocarbon group or an alkoxy group, and n represents an integer of 1 or more, with the proviso that when n is 2 or more, a plurality of R²¹ and R²² may be the same or different.

5. The liquid developer according to claim 4, wherein the block copolymer B′ comprises at least two polymer blocks P having Formula (1) as a repeating unit and at least one polymer block Q having Formula (2) as a repeating unit.

6. The liquid developer according to claim 4, wherein when a content of the repeating unit of Formula (1) in the block copolymer B′ is b1% by mass, and a content of the repeating unit of Formula (2) in the block copolymer B′ is b2% by mass, b1/b2 is 0.050 or more and 19 or less.

7. The liquid developer according to claim 6, wherein the b1/b2 is 0.67 or more and 9.0 or less.

8. The liquid developer according to claim 1, wherein a content of a moiety derived from (meth)acrylic acid in the ethylene-(meth)acrylic acid copolymer A is 1 mass % or more and 30 mass % or less.

9. The liquid developer according to claim 1, wherein the carrier liquid comprises at least one selected from the group consisting of a paraffin, a naphthene and an olefin.

10. The liquid developer according to claim 1, wherein the carrier liquid comprises isoparaffin.

11. The liquid developer according to claim 1, wherein the hard segment and the soft segment have different crystallinities.

12. An image forming method using the liquid developer according to claim 1.

13. A liquid developer cartridge having the liquid developer according to claim 1.

14. An image forming apparatus having the liquid developer according to claim 1.

15. A liquid developer comprising a carrier liquid and a developer component,
wherein the developer component comprises an ethylene-(meth)acrylic acid copolymer A and a polymer B comprising a repeating unit of the following Formula (1): 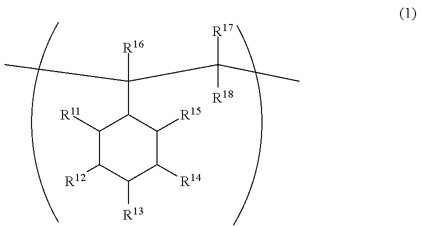
wherein, in Formula (1), R¹¹ to R¹⁸ each independently represent a hydrogen atom, a halogen atom, a hydrocarbon group, or an alkoxy group.

16. The liquid developer according to claim 15, wherein the repeating unit of Formula (1) comprises any one of the following structures:

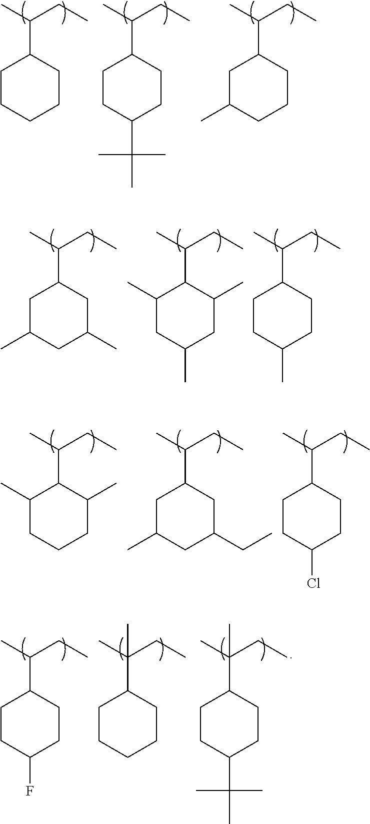

17. The liquid developer according to claim 15, wherein the repeating unit of Formula (1) comprises any one of the following structures:

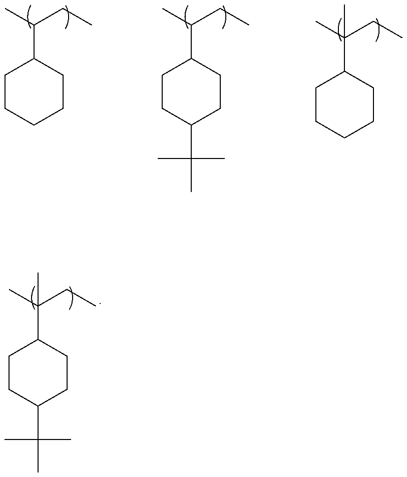

18. The liquid developer according to claim 15, wherein the repeating unit of Formula (1) comprises the following structure:

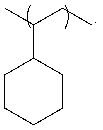

19. The liquid developer according to claim 4, wherein the repeating unit of Formula (2) comprises any one of the following structures:

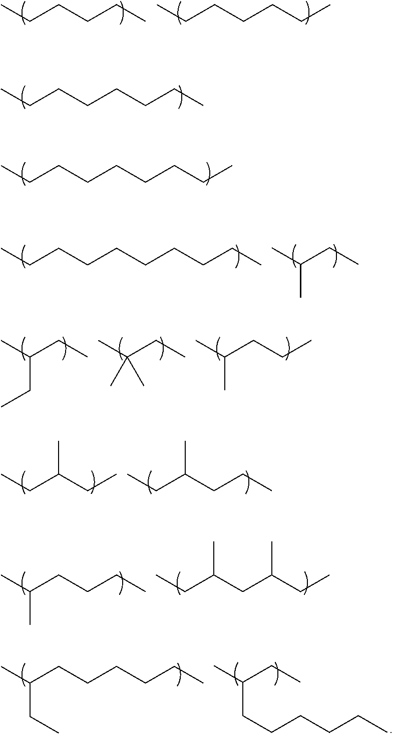

20. The liquid developer according to claim 4, wherein the repeating unit of Formula (2) comprises any one of the following structures:

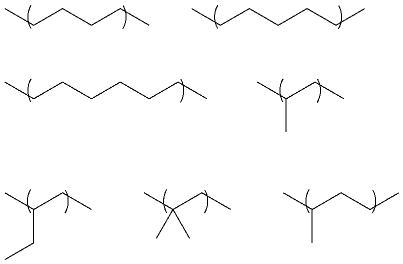

21. The liquid developer according to claim 4, wherein the repeating unit of Formula (2) comprises either one of the following structures:

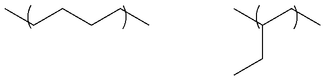

22. A liquid developer comprising a carrier liquid and a developer component,
wherein the developer component comprises an ethylene-(meth)acrylic acid copolymer A and a block copolymer B′ comprising a first segment and a second segment,
the first segment and the second segment have different crystallinities, and
the first segment is a vinyl alicyclic hydrocarbon polymer.
